(19) United States
(12) Patent Application Publication
(10) Pub. No.: US 2016/0202389 A1
(43) Pub. Date: Jul. 14, 2016

(54) H-MATRIX PRECONDITIONER

(71) Applicant: Schlumberger Technology Corporation, Sugar Land, TX (US)

(72) Inventors: Emmanuel Malvesin, Grabels (FR); Frantz Maerten, Grabels (FR)

(21) Appl. No.: 14/594,219

(22) Filed: Jan. 12, 2015

(51) Int. Cl. G01V 99/00; G06F 17/16

(52) U.S. Cl. CPC G01V 99/005; G06F 17/16

(57) ABSTRACT

A method can include receiving a system of equations with associated variables that describe physical phenomena associated with a geologic formation; representing a matrix for the system of equations as a tree of blocks; classifying a portion of the blocks as being near blocks and another portion of the blocks as being far blocks; and based on the classification of the near blocks, computing a preconditioner for an iterative solver for solving the system of equations.

### BACKGROUND

Reservoir simulation involves modeling various physical phenomena over a geologic environment. A model may involve spatially gridding a geologic environment for purposes of discretizing equations that describe physical phenomena. For a particular geologic environment, such a model may include millions of equations with millions of unknowns. A solver may structure the equations and unknowns in the form of vectors, matrices, etc. Depending on relationships between variables, locations of features within a geologic environment, etc., a solver may structure a matrix that may be considered to be sparse or dense. Such matrix characteristics can impact a solver's performance, including its ability to solve a system of equations.

### SUMMARY

A method can include receiving a system of equations with associated variables that describe physical phenomena associated with a geologic formation; representing a matrix for the system of equations as a tree of blocks; classifying a portion of the blocks as being near blocks and another portion of the blocks as being far blocks; and based on the classification of the near blocks, computing a preconditioner for an iterative solver for solving the system of equations. A system can include a processor; memory; and at least one module stored in the memory that includes processor-executable instructions to instruct the system where the instructions can include instructions to receive a system of equations with associated variables that describe physical phenomena associated with a geologic formation; represent a matrix for the system of equations as a tree of blocks; classify a portion of the blocks as being near blocks and another portion of the blocks as being far blocks; and based on the classification of the near blocks, compute a preconditioner for an iterative solver for solving the system of equations. Computer-readable storage media can include processor-executable instructions to instruct a computing system where the instructions include instructions to receive a system of equations with associated variables that describe physical phenomena associated with a geologic formation; represent a matrix for the system of equations as a tree of blocks; classify a portion of the blocks as being near blocks and another portion of the blocks as being far blocks; and based on the classification of the near blocks, compute a preconditioner for an iterative solver for solving the system of equations. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geologic environment;

FIG. 2 illustrates an example of a sedimentary basin, an example of a method, an example of a formation, an example of a borehole, an example of a borehole tool, an example of a convention and an example of a system;

FIG. 3 illustrates an example scenario;

FIG. 4 illustrates an example of a method and an example of a system;

FIG. 5 illustrates an example of a method;

FIG. 6 illustrates an example of a method;

FIG. 7 illustrates an example of a method; and

FIG. 8 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Subterranean formations, and related physical phenomena, may be modeled using various techniques. Such techniques can involve gridding, or other discretization, of one or more subterranean volumes that make up a formation. As an example, a process may include performing stress inversion via a geomechanical model. Where a formation includes one or more fluids (e.g., gas, liquid, or both), a modeling technique may include formulating equations that account for physical phenomena such as pressure, saturation and composition.

As an example, finite elements may be part of a formulation of the finite element method (FEM) and boundary elements may be part of a formulation of the boundary element method (BEM). As an example, equations may be discretized spatially according to elements where the equations may be represented in matrix form. As an example, an accounting procedure may relate variables, elements, etc. with reference to positions of elements. Such a procedure may determine one or more characteristics of a matrix or matrixes. For example, an element may depend on, or be linked to, neighboring elements. In a matrix, one or more bands may be present where a bandwidth corresponds to one or more relationships between variables, elements, equations, etc.

As an example, a boundary element formulation that discretizes a physical space may give rise to a matrix structure that is denser than that of a finite element formulation. For example, individual boundary elements may “interact” with other boundary elements as to mathematical terms that represent physical phenomena. Such interactions (e.g., interaction terms) tend to make a matrix more dense. As an example, a boundary element formulation may give rise to a fully populated matrix. As an example, storage and computational time may tend to grow according to the square of a problem size for a boundary element formulation (e.g., according to a square of a number of degrees of freedom); whereas, for a finite element formulation, a matrix structure may be banded (e.g., elements locally connected) such that storage may grow linearly with problem size.

As an example, a method that implements a boundary element formulation may resort to one or more compression techniques that may act to reduce storage for data structures (e.g., dense matrixes). As an example, a compression technique may be a hierarchical technique such as, for example, an H-matrix technique. Such a technique may include representing a matrix as a tree structure and classifying entries (e.g., blocks) according to one or more criteria. For example, blocks in a tree structure may be classified using a diameter criterion (e.g., a distance criterion) as being near blocks or as being far blocks.

As an example, for a boundary element formulation, a sub-matrix block of a theoretical matrix (e.g., a matrix given by the application of the boundary element method) may describe the interaction of two subsets of elements. In such an example, individual elements may be labeled from 0 to N where N is the number of elements of a model of a physical space; thus, a subset of elements may be seen as a subset of an index of {1,2, . . . , N}. In such an example, a dense matrix may be defined, for example, as an N×N matrix that includes interaction terms.

As an example, a near/far criterion may act to classify “interactions” between two subsets of elements as being near or far. Such a criterion may be, for example, a distance. For example, consider a boundary element formulation that discretizes a model of a physical space using triangles. In such an example, a triangle may include a dimension parameter such the square root of its area. As an example, a distance criterion may be defined to be a value of about five to about ten times the dimension parameter of the triangle. Such a criterion may be applied to classify interactions between two subsets of elements as being near (e.g., less than or equal to the distance criterion) or far (e.g., greater than the distance criterion). In terms of a physical space, a dimension of a triangle may be, for example, of the order of meters (e.g., depending on the physical space, phenomena to be modeled, etc.).

As an example, in a boundary element formulation, “interactions” that are deemed to be “near” may correspond to physical phenomena that can operate over a physical distance (e.g., as represented by a distance criterion); whereas, “interactions” that are deemed to be “far” may correspond to physical phenomena that may or may not operate over a physical distance (e.g., as represented by a distance criterion) and where they may, the influence of such phenomena may be considered to be less than that of “interactions” deemed to be “near”. As an example, a method may include representing near blocks with greater accuracy than the far blocks. For example, far blocks may be subject to an approximation technique (e.g., adaptive cross-approximation (ACA), etc.).

As an example, a geomechanical framework can include one or more modules that include processor-executable instructions. As an example, such a framework can include instructions to implement the boundary element method (BEM) where surfaces in space are described at least in part via boundary elements. As an example, such a framework may include equations that can describe angular dislocations, for example, for modeling three-dimensional stress fields. As an example, a model may provide for modeling of discontinuities in an elastic, heterogeneous, isotropic whole- or half-space.

As an example, a method may include modeling an oil and gas field that spans a volume measured in kilometers. A model of such a field may include many thousands of grid cells or grid points where each cell or point has associated values, which may be equation unknowns, for example, optionally with respect to time. Given initial values (e.g., initial conditions) and boundary values (e.g., boundary conditions), an iterative solution technique may be applied to the model equations to determine the equation unknowns at one or more points in time (e.g., steady-state or transient).

As physical phenomena related to a subterranean formation may be interrelated, model equations may be coupled to varying degrees. Resulting mathematical matrices that represent coupled systems of equations may be “sparse” with many zero entries and many off-diagonal terms (e.g., as may exist for a finite element formulation (e.g., FEM)). For large matrices, an algorithm can account for “sparsity”; noting that failure to account for sparsity can result in increased storage and computational demands. Transformation techniques such as preconditioning can help improve the “condition” of a matrix (e.g., to avoid an ill-conditioned system of equations). Preconditioning can reduce the condition number of a system and thereby improve convergence of an iterative solution technique, improve computational stability and improve trust in the solution values for unknowns.

As an example, preconditioning can also improve computational stability and trust in solution values for unknowns where a matrix may be dense. For example, preconditioning may be applied to facilitate solution of equations of a model formulated using boundary elements (e.g., BEM).

In mathematics, the generalized minimal residual method, which may be abbreviated as GMRES, is an iterative method for the numerical solution of a system of linear equations. The method approximates the solution by a vector in a Krylov subspace K with minimal residual where the Arnoldi iteration may be used to find the vector. GMRES approximates the exact solution of Ax=b by the vector xₙ, ∈Kₙ, that minimizes the Euclidean norm of the residual Axₙ-b.

Krylov subspace methods such as GMRES or Orthomin find use as basic solvers, which may be implemented in parallel. However, efficiency of these solvers relies on defining a suitable preconditioner to improve the condition number of a linear system.

Preconditioners (e.g., preconditioning techniques) are useful in iterative methods that can solve a linear system of equations such as Ax=b for unknowns of vector x. This is because the rate of convergence of these iterative methods tends to improve as the condition number of the matrix A decreases. Thus, for such scenarios, preconditioning the system improves the convergence. Preconditioning involves selection of a matrix P, such that the preconditioned system may be represented as, for example: P⁻¹Ax=P⁻¹b.

One criterion for preconditioning is that the preconditioning matrix may be readily inverted. Further, to reduce the number of iterations, it may also be desirable that P be “close” to A in the sense that the spectral radius of I-P⁻¹A be small, where I is the identity matrix (i.e., entries of unity along a main diagonal and zeros elsewhere). Preconditioning can present trade-offs between performing a small number of intensive iterations and a large number of less intensive iterations. Preconditioning may be “left-sided”, “right-sided” or both left- and right-sided (e.g., two-sided).

As an example, a method can include implementing a hierarchical matrix technique, which may be an H-matrix technique. For example, such a technique may be implemented as part of a process to compute a preconditioner for an iterative solver. In such an example, based on an H-matrix structure, low range blocks may be neglected in building the preconditioner. Such an approach can reduce load on computational and memory. As an example, combined with a GMRES approach, such an iterative solver may exhibit improved stabilization in the context of stress inversion with ill-posed systems.

As an example, GMRES approach may be implemented in an iterative method for a numerical solution of a nonsymmetrical system of linear equations. In such an example, the method may seek a solution in a small subspace (e.g., Krylov subspace) while minimizing a residual. Such an approach may be applied, for example, in an acoustic (LMS-sysnoise solver), electromagnetism, fluid mechanics, etc.

As to hierarchical matrices, these may be implemented to efficiently represent data of densely populated matrices. For example, an H-matrix technique can include recursive splitting of a matrix into a hierarchy of blocks. As an example, via one or more separation criteria, a portion of the blocks may be stored in full while another portion of the blocks may be approximated, for example, by a low rank matrix. Such a technique may be implemented for matrices, for example, arising in formulations that use the boundary element method (BEM) or, for example, to store an inverse matrix resulting of a finite element method (FEM).

As an example, an incomplete factorization preconditioner (e.g., ILUT) combined with a Krylov subspace as GMRES can find use in iteratively solving large systems of linear equations. The ILUT procedure is a variant of a LU decomposition where some coefficients are dropped based on their relative values. The ILUT approach can use two parameters: a threshold drop tolerance and a fill number (e.g., that specifies what fraction of the factorization is kept).

As an example, a method can, during computation of a preconditioner, implement an H-matrix structure, for example, with an aim of reducing computational demands. In such an example, considering that far parts of a model may yield some approximated blocks, an assumption may be made that the contribution of such blocks may be neglected during computation of a preconditioner. Such an approach may reduce memory and computational demands.

As mentioned, ILUT performs an approximation of an LU whose accuracy may be controlled by two parameters (t) serving as a threshold for the magnitude of the entries retained and (p) used to control memory consumption by limiting the number of non-zero entries into a decomposition. In the limit where (t) is zero and (p) is equal to the dimension of the matrix, the resulting decomposition is the LU decomposition of the initial matrix and, in such an example, a preconditioning process may be solved in a single run of an initial system.

Among the other preconditioning techniques, ILUT has proven to be applicable to a large number of different physics. In particular they can provide an alternative to the smoothers (e.g., Jacobi, Gauss-Seidel, etc.) for which convergence is subjected to conditions on the spectrum of their iteration matrices.

As an example, an H-matrix technique may be implemented as part of preconditioning for an iterative method where, for example, a space is discretized using elements (e.g., boundary elements and/or finite elements).

As mentioned, a method may be applied as part of a framework. For example, a framework may include features for modeling a geologic environment. As an example, seismic interpretation may be performed using seismic to simulation software such as the PETREL® seismic to simulation software framework (Schlumberger Limited, Houston, Tex.), for example, as part of a workflow for building a model. While the PETREL® seismic to simulation software framework is mentioned, other types of software, frameworks, etc., may be employed for purposes building a model. As an example, a framework such as the iBem3D™ framework iBem3D, formally Poly3D™ (Schlumberger Limited, Houston, Tex.) may be implemented for building a model, solving equations, etc.

As an example, the iBem3D™ framework may be implemented for forward stress modeling, for example, using one or more modules. As an example, such a package may implement a boundary element method (BEM). Such a framework may provide for characterization and modeling of subseismic fractures, which may facilitate better drilling decisions (e.g., using fundamental principles of physics that govern rock deformation). For example, output may include modeled density and orientation of subseismic faults in a region (e.g., which may include a reservoir or reservoirs).

As an example, a framework may provide for 3D fault modeling. In such an example, a workflow may aim to identify regions of hydrocarbons for possible recovery. Multi-dimensional fault modeling may facilitate building and/or supplementing a geologic model of reservoir structure. Forward capabilities in a framework may help to reduce uncertainty in seismic interpretation of complex fault networks and allow more accurate under-constrained complex geological models to be built, analyzed, etc.

As to well design, drilling in structurally complex reservoirs can present challenges, especially when an area may be tectonically active. A framework may provide for creation of multi-dimensional models, for example, of present-day heterogeneous stress fields that may be caused by active faulting, salt diapir, etc.

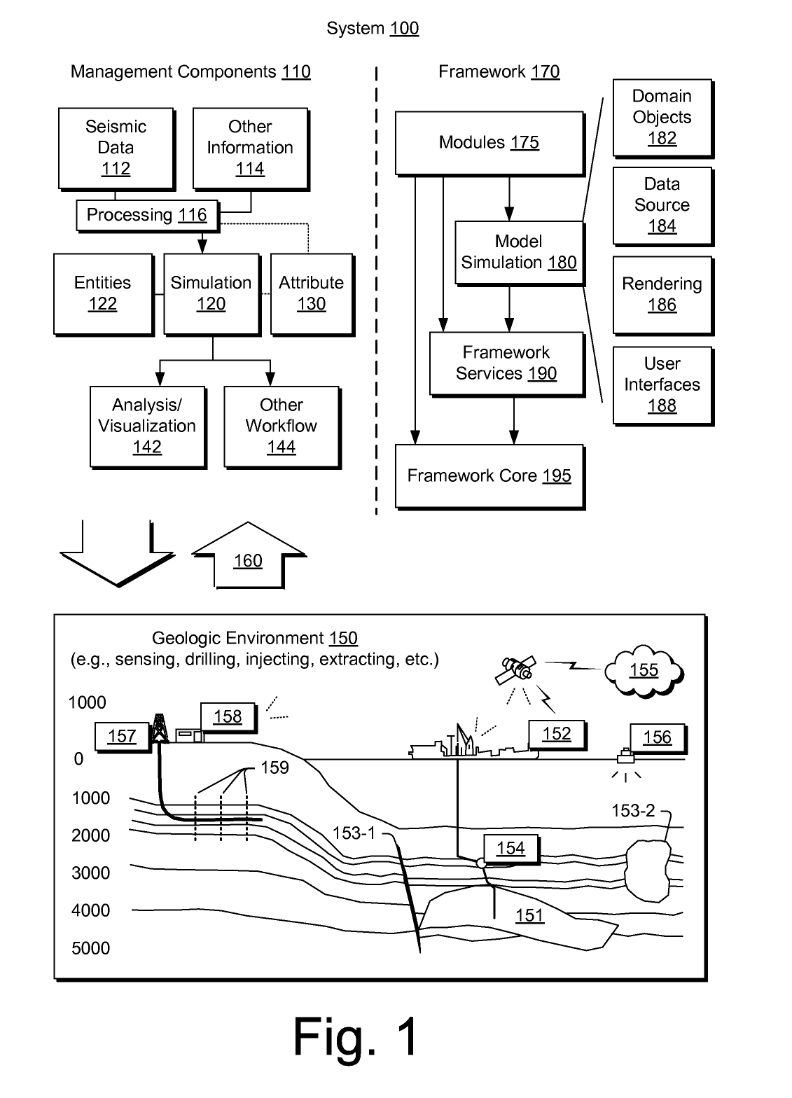

FIG. 1 shows an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Tex.) allows for integration of add-ons (or plug-ins) into a PETREL® framework workflow. The OCEAN® framework environment leverages .NET™ tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

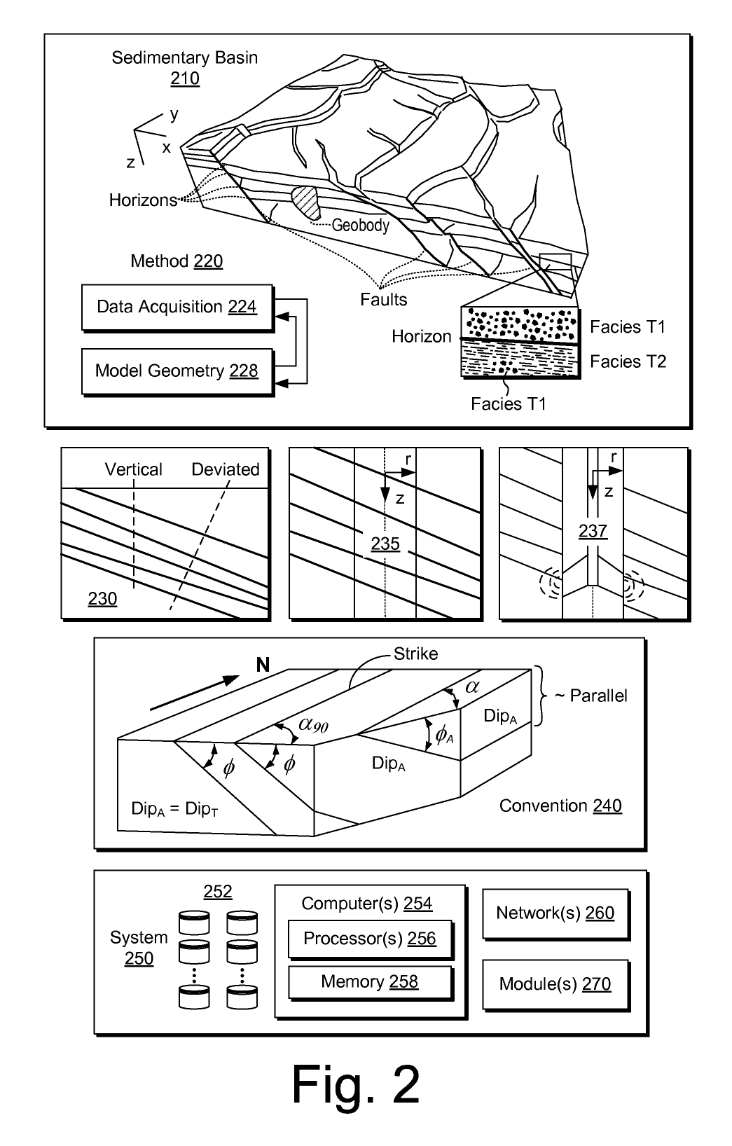

FIG. 2 shows an example of a sedimentary basin 210 (e.g., a geologic environment), an example of a method 220 for model building (e.g., for a simulator, etc.), an example of a formation 230, an example of a borehole 235 in a formation, an example of a convention 240 and an example of a system 250.

As an example, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

To proceed to modeling of geological processes, data may be provided, for example, data such as geochemical data (e.g., temperature, kerogen type, organic richness, etc.), timing data (e.g., from paleontology, radiometric dating, magnetic reversals, rock and fluid properties, etc.) and boundary condition data (e.g., heat-flow history, surface temperature, paleowater depth, etc.).

In basin and petroleum systems modeling, quantities such as temperature, pressure and porosity distributions within the sediments may be modeled, for example, by solving partial differential equations (PDEs) using one or more numerical techniques. Modeling may also model geometry with respect to time, for example, to account for changes stemming from geological events (e.g., deposition of material, erosion of material, shifting of material, etc.).

A commercially available modeling framework marketed as the PETROMOD® framework (Schlumberger Limited, Houston, Tex.) includes features for input of various types of information (e.g., seismic, well, geological, etc.) to model evolution of a sedimentary basin. The PETROMOD® framework provides for petroleum systems modeling via input of various data such as seismic data, well data and other geological data, for example, to model evolution of a sedimentary basin. The PETROMOD® framework may predict if, and how, a reservoir has been charged with hydrocarbons, including, for example, the source and timing of hydrocarbon generation, migration routes, quantities, pore pressure and hydrocarbon type in the subsurface or at surface conditions. In combination with a framework such as the PETREL® framework, workflows may be constructed to provide basin-to-prospect scale exploration solutions. Data exchange between frameworks can facilitate construction of models, analysis of data (e.g., PETROMOD® framework data analyzed using PETREL® framework capabilities), and coupling of workflows.

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230. As an example, a tool 237 may be positioned in a borehole, for example, to acquire information. As mentioned, a borehole tool may be configured to acquire electrical borehole images. As an example, the fullbore Formation MicroImager (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole may be vertical, deviate and/or horizontal. As an example, a tool may be positioned to acquire information in a horizontal portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG® framework (Schlumberger Limited, Houston, Tex.).

As to the convention 240 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 240 of FIG. 2, various angles φ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 240 of FIG. 2). True dip is the dip of a plane measured directly perpendicular to strike (see, e.g., line directed northwardly and labeled “strike” and angle α₉₀ ) and also the maximum possible value of dip magnitude. Another term is “apparent dip” (see, e.g., Dip_{A} in the convention 240 of FIG. 2). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 240 of FIG. 2, the dip of a plane as seen in a cross-section perpendicular to the strike is true dip (see, e.g., the surface with φ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 240 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 240 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.). As an example, dip may change spatially as a layer approaches a geobody. For example, consider a salt body that may rise due to various forces (e.g., buoyancy, etc.). In such an example, dip may trend upward as a salt body moves upward.

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As an example, equations may be provided for petroleum expulsion and migration, which may be modeled and simulated, for example, with respect to a period of time. Petroleum migration from a source material (e.g., primary migration or expulsion) may include use of a saturation model where migration-saturation values control expulsion. Determinations as to secondary migration of petroleum (e.g., oil or gas), may include using hydrodynamic potential of fluid and accounting for driving forces that promote fluid flow. Such forces can include buoyancy gradient, pore pressure gradient, and capillary pressure gradient.

As shown in FIG. 2, the system 250 includes one or more information storage devices 252, one or more computers 254, one or more networks 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252.

As an example, the one or more modules 270 may include instructions (e.g., stored in memory) executable by one or more processors to instruct the system 250 to perform various actions. As an example, the system 250 may be configured such that the one or more modules 270 provide for establishing the framework 170 of FIG. 1 or a portion thereof. As an example, one or more methods, techniques, etc. may be performed using one or more modules, which may be, for example, one or more of the one or more modules 270 of FIG. 2.

As an example, a stress inversion may be performed using one or more assumptions. For example, consider the Wallace-Bott hypothesis, which is based on slip on a fault surface has a common direction and sense as a maximum shear stress resolved on that surface. Underlying assumptions of the Wallace-Bott hypothesis include faults are planar, blocks are rigid, neither stress perturbations nor block rotations along fault surfaces occur and that the applied stress state is uniform. However, complex fault geometries, heterogeneous fault slip directions, evidence of stress perturbations in microstructures and block rotations along fault surfaces can exist. For example, striation lines (slip vectors) may not necessarily be parallel to a maximum shear stress vector and may be consistent with local stress perturbations. As an example, an approach to stress inversion may include a geomechanical model that may be defined in part via elements such as, for example, finite element and/or boundary elements.

As an example, finite elements may be part of a formulation of the finite element method (FEM) and boundary elements may be part of a formulation of the boundary element method (BEM). As an example, equations may be discretized spatially according to elements where the equations may be represented in matrix form. As an example, an accounting procedure may relate variables, elements, etc. with reference to positions of elements. Such a procedure may determine one or more characteristics of a matrix or matrixes. For example, an element may depend on, or be linked to, neighboring elements.

As mentioned, a matrix associated with the BEM may be denser than a matrix associated with the FEM. As an example, a matrix associated with the BEM may be represented using a technique such as an H-matrix technique. Such a technique may represent a matrix as a tree structure that includes blocks where blocks may be classified according to one or more criteria to be near blocks or far blocks. In such an example, a preconditioner may be computed using the near blocks. As an example, a solver may solve for values of unknowns using the near and far blocks where information associated with far blocks may be approximated. As an example, post-processing may include assessing results of a solver based at least in part on a data structure and/or data classification based on an H-matrix technique.

As an example, a geomechanical framework can include one or more modules that include processor-executable instructions. As an example, such a framework can include instructions to implement the boundary element method (BEM) where surfaces in space are described at least in part via boundary elements. As an example, such a framework may include equations that can describe angular dislocations, for example, for modeling three-dimensional stress fields. As an example, a model may provide for modeling of discontinuities in an elastic, heterogeneous, isotropic whole- or half-space.

As an example, a framework may generate a formulation that can describe geological objects such as faults. In such an example, geometries may be modeled, for example, optionally without gaps and overlaps between adjacent dislocation elements. As an example, a framework may utilize triangular dislocation elements. As an example, a framework may provide for one or more of subseismic fault modeling, fractured reservoir modeling, interpretation and validation of fault connectivity and reservoir compartmentalization, depleted area and fault reactivation, and/or pressurized wellbore stability. As an example, a framework may provide for modeling earthquakes, volcanos, hazards, hazard mitigation, slope stability, etc.

As an example, a method can include modeling dislocations in elastic materials, for example, to evaluate displacement, strain, and stress fields around faults. As an example, a method can include modeling of viscoelastic materials that may exhibit behavior characteristic of classical Hookean solids (e.g., “spring”) and Newtonian fluids (e.g., “dashpot”). In such an example, materials may deform under applied load where the load may be, for example, due to externally applied forces, internal deformation caused by a diffusing penetrant, constrained thermal expansion caused by temperature gradients, etc. As an example, a viscoelastic material may possess “memory” as to its response history. Such memory may be manifest in constitutive relationship between stress and strain tensors. As an example, a mathematical model of viscoelastic behavior may take a partial differential Volterra equation form (e.g., consider forms such as elliptic, parabolic, and hyperbolic).

As an example, a model may consider stress carried by a spring where stress is proportional to strain in the spring, for example, via Hooke's law where, for example, stress is carried in a dashpot that is proportional to a strain rate as may be given by Newton's law of viscosity. In such an example, a viscoelastic material may be modeled by considering springs and dashpots with independent stiffness and viscosity parameters (e.g., consider Maxwell and Voigt representations for series and parallel connections, respectively). As an example, an internal variable formulation of a model may provide for construction of a Maxwell solid (e.g., with Maxwell and Voigt representations).

As an example, a model may include equations for dynamic response of a viscoelastic body, for example, via Newton's second law to relate a stress field and forces and gravity to acceleration, or inertia, of a body. As an example, by removing stress from a transport equation (e.g., a diffusion equation) and using mass conservation, a formulation may be given as a differential-Volterra equation.

As an example, a Volterra formulation for a dislocation can include construction of Green's functions, for example, for a semi-infinite space that includes a surface of displacement discontinuity (e.g., a dislocation). In such an example, Green's functions may be integrated to calculate the displacement field around the planar surface of discontinuity. Such displacement fields may satisfy the Navier equations (e.g., governing equations for linear elastics). In such an example, spatial derivatives of the displacement components may provide strain components, and incorporation of Hooke's law for a homogeneous and isotropic elastic material may give stress components. As an example, a dislocation approach may allow for computation of displacement, strain, and stress fields around idealized faults in an elastic half-space; however, a desire may exist for comparisons to geophysical data.

As an example, a method can include correlating to observations, for example, to bridge a dislocation approach to a mechanical analysis of faulting. As an example, a method may include integration of Volterra's dislocation over rectangular surfaces in a half-space. As an example, a method may include one or more analytical expressions for deformation at a surface of a half-space that results from inclined shearing and opening rectangular dislocation surfaces.

As mentioned, a method may include an element-based approach such as, for example, a boundary element method (BEM) based approach. As an example, a BEM approach can provide for calculation of displacements, strains, and stresses induced in an elastic whole- or half-space. In such an example, boundary elements may be triangular (e.g., by planar triangular-shaped elements of displacement discontinuity). As an example, such elements may be constructed by superposition of angular dislocations.

As an example, elastic fields around elements may be derived from solution for a single angular dislocation in an elastic half-space or whole-space. Geologically, a triangular element may represent some portion of a fracture or fault surface across which a discontinuity in displacement is approximately constant. As an example, several triangular dislocation elements may be used to model faults or fractures; noting that some may be joined to form a closed surface that may represent a finite elastic body or a void in an otherwise infinite or semi-infinite elastic body. Such superposition may provide for modeling geological structures with various 3D boundaries and shapes, which may not be amenable to modeling with rectangular elements as curved surfaces may result in gaps and/or overlaps.

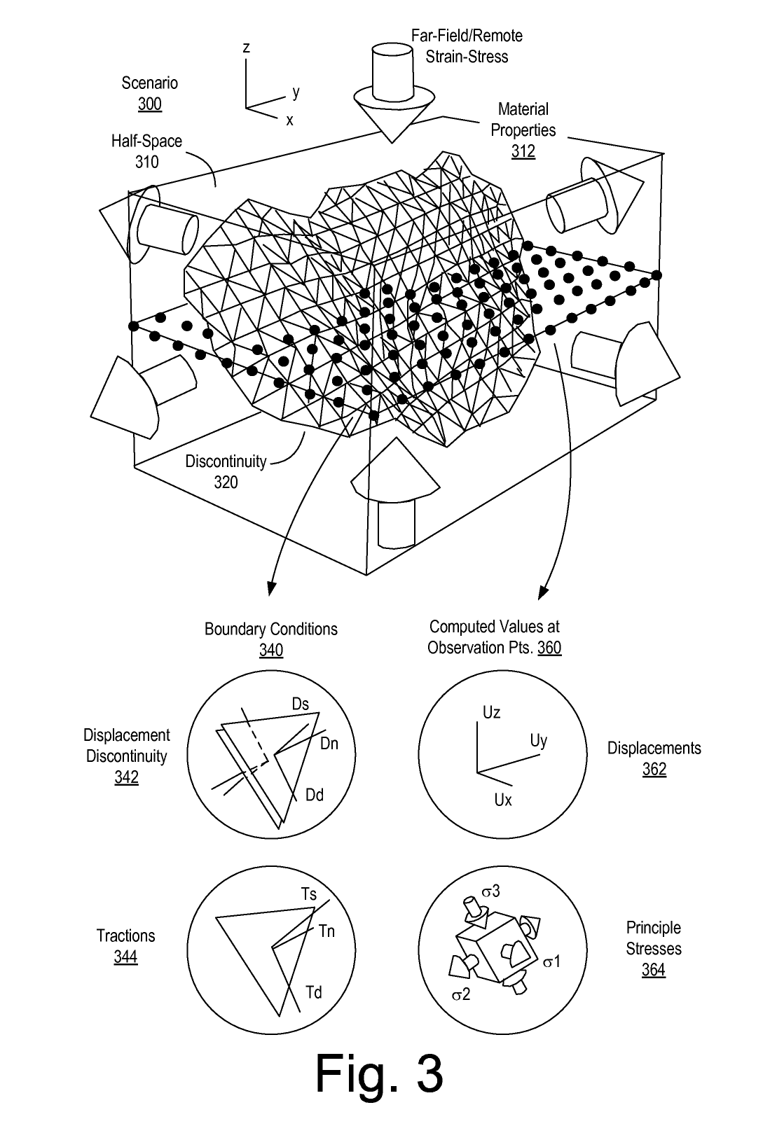

FIG. 3 shows an example scenario 300 of construction of a fault geometry using triangular elements and a schematic representation of a surrounding observation grid. In particular, a half-space 310 includes material properties 312 and a discontinuity 320 (e.g., a fault surface). Boundary conditions 340 on triangular elements may be a combination of displacement discontinuity conditions 342 and traction conditions 344, for example, defined in an element coordinate system. As an example, an element coordinate system may be such that the x- and y-axes are along the dip- and strike-directions, respectively. In such an example, the z-axis may be aligned with the normal of an element. At individual observation points, displacements 362 and stresses and strains 364 may be computed (e.g., optionally as a post-process). FIG. 3 also shows 3D remote strain or stress (e.g. far-field effects).

As illustrated in FIG. 3, boundary conditions may be defined as to a doubly triangulated surface (e.g., one for each region or side of a discontinuity) that are coincident with oppositely directed normal vectors. As an example, a region may be characterized by a homogeneous and isotropic material and elastic moduli may differ from region to region. An interface between two different regions can transmit the mechanical influence of one region on the other, for example, by computing the corresponding Burgers vectors for two adjacent elements on the interface using continuity and equilibrium conditions prescribed in a global coordinate system (e.g., different regions can be linked through the continuity and equilibrium conditions at an interface).

As an example, a method may include retrieving slip distribution on one or more 3D faults, for example, given measurements of ground displacements (e.g., from global positioning system (GPS), synthetic aperture radar interferometry (InSAR), etc.), optionally associated with one or more tectonic events such as earthquakes, etc. As an example, an indirect boundary element method may be implemented for an inversion. As an example, a weighted least-squares approach combined with a Tikhonov regularization may be implemented. As an example, a system of equations may be solved with a constrained solver to generate a solution.

As an example, constraints may allow slip components to invert to be either negative or positive. As an example, a forward formulation may be extended to linear slip inversion. In such an example, triangular elements may be implemented, for example, to reduce risk of gaps and overlaps between adjacent elements, which can lead to numerical artifacts (e.g., as may exist with rectangular elements). As an example, a method may implement triangular elements to model information close to a fault.

As an example, a method may, given data that constrain fault geometry, as well as boundary conditions on elements making up a fault, include determining remote stress or strain to apply to a model. For example, using an iteratively coupled double system, paleostress may be estimated given measures of the displacement discontinuity on at least some parts of faults. As an example, throw and/or dip-slip measurements may be available from reflection seismic interpretation.

As an example, a method may include inverting for paleostress. In such an example, the method may recover (e.g., simultaneously) the unknown displacement discontinuities on faults. Such an approach can allows for extending the fault geometry, if desired, and to compute the unknown dip- and strike-slip.

As an example, a method can include performing paleostress analysis via the principle of superposition that can apply to linear elasticity for heterogeneous, isotropic whole- of half-space media. As an example, given some measures of fault throw, dip-slip, slickenline directions, stress measurements as well as fault geometry, GPS data, InSAR data, fractures (joints, veins, dikes, pressure solution seams with stylolites), micro-seismicity, breakout orientations or secondary fault plane orientations, a method may include recovering remote stress state for multiple tectonic events (e.g., efficiently using a mechanical scenario). As an example, in an implementation of the principle of superposition, an individual simulation may be performed in constant time. As an example, a method may include performing one or more and Monte-Carlo simulations.

As mentioned, a method can include implementing an H-matrix technique during computation of a preconditioner. An H-matrix approach can include clustering a matrix into several blocks such that near-field block influences are retained whereas far-field blocks can be approximated by interpolation or rank reduction. As an example, a geometrical rule may be selected for clustering. As an example, a recursive bisection rule may be applied. In such an example, using a kd-tree, a subdivision by bisection may be applied recursively, leading to a binary tree of blocks with a root. As an example, recursive subdivision may terminate when the number of items in a block reaches a prescribed minimum. A result can be a binary partition of the model made of blocks. Given such a result, a method may include determining near- and far-field blocks using this decomposition.

As an example, given two blocks C1 and C2, an admissible condition may be min(diam(C1), diam(C2))≦dist(C1,C2) to check whether C1 and C2 may be used for approximation. A diameter can be a set of points C, diam(C), being the maximal distance between a pair of points in C, for example, defined as diam(C)=max∥p-q∥ where p and q are within C. As an example, the distance between two sets of points, dist(C,D), may be defined as dist(C,D,)=min∥p-q∥ where p is within C and q is within D.

As an example, an H-matrix technique may commence at a root of a tree and generate an H-matrix as a structure. In such an example, at least a portion of the blocks may be deemed to be near and at least a portion of the blocks may be deemed to be far. As an example, considering that far parts of a model yield some approximated blocks, a method can include assuming that the contribution of such blocks can be neglected during the computation of a preconditioner.

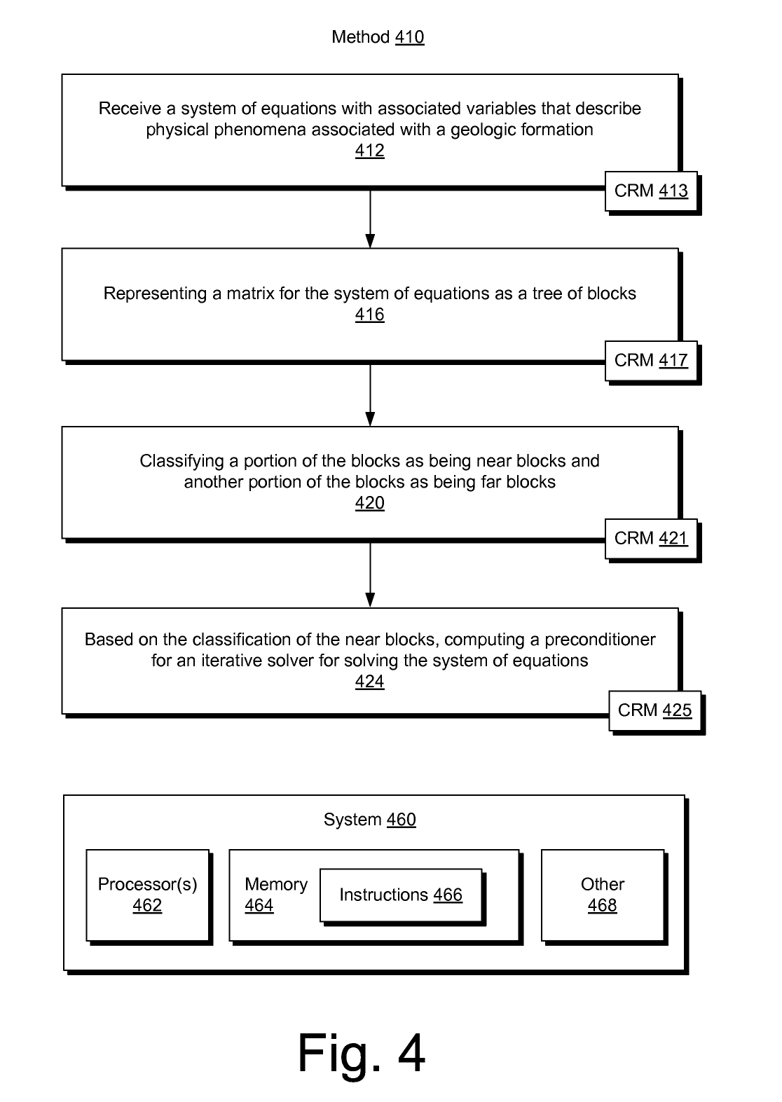

FIG. 4 shows an example of a method 410 and an example of a system 460. As shown, the method 410 includes a reception block 412 for receiving a system of equations with associated variables that describe physical phenomena associated with a geologic formation, a representation block 416 for representing a matrix for the system of equations as a tree of blocks, a classification block 420 for classifying a portion of the blocks as being near blocks and another portion of the blocks as being far blocks, and a computation block 424 for computing, based on the classification of the near blocks, a preconditioner for an iterative solver for solving the system of equations. For example, the preconditioner may be computed based on the near blocks and not the far blocks.

As an example, the method 410 of FIG. 4 can include recursively splitting the matrix into a hierarchy of blocks to form a tree of blocks. As an example, the method 410 of FIG. 4 can include implementing at least one separation criterion to classify blocks where, for example, some blocks are stored while others are approximated (e.g., by a low rank matrix).

As an example, the method 410 of FIG. 4 may include computing an ILUT preconditioner based on near block terms, for example, as determined using an H-matrix technique. As an example, such a preconditioner may be combined with a Krylov subspace and implemented in a GMRES algorithm, for example, in a method that can iteratively solve a system of linear equations. As an example, a method may include computing a preconditioner that is a variant of a LU decomposition where, for example, some coefficients may be dropped based on their relative values. As an example, an ILUT approach may implement two parameters: a threshold drop tolerance and a fill number (e.g., that specifies what fraction of a factorization is kept).

As an example, a preconditioner may be computed where the contribution of at least a portion of blocks of a matrix represented as a tree of blocks are neglected. For example, such block may be considered to be far parts of a model. As an example, a classification scheme may be implemented to classify a portion of blocks as being far parts of a model.

As an example, a method can include allocating memory based at least in part on an H-matrix technique. For example, where such an H-matrix technique is applied such that a portion of blocks of a tree structure may be deemed far parts of a model, such blocks may be neglected in computing a preconditioner. Where such blocks are neglected, memory may be allocated for computing a preconditioner based at least in part on blocks that are not deemed far parts of a model (e.g., based at least in part on a total number of blocks less the far blocks). As an example, an approximated block, being deemed to be a far part of a model, may be neglected in a computation of a preconditioner.

As an example, a linear solver may utilize a direct method or an iterative method to determine a solution. As to a direct method, consider Gaussian elimination where a matrix is factorized into a product of a lower triangular matrix, L, and upper triangular matrix, U (e.g., A=LU). For large sparse matrices, computation of triangular matrices L and U can become expensive as the number of non-zero entries in each factor becomes large.

As an example, for an iterative method, a linear system of equations may be solved using approximations to a matrix. For example, an incomplete lower-upper ILU factorization may be used, instead of a full factorization as in the direct method. In such an example, a product of sparse factors L and U may be computed such that their product approximates the matrix (A=LU). When employing an iterative method, a solution is updated in an iterative manner until convergence is reached (e.g., some proscribed error limit or limits have been met). Iterative methods may converge slowly for large systems of linear equations because the number of iterations can increase as a number of unknowns increases.

As to preconditioning, it may be implemented in an effort to decrease a number of iterations in an iterative method to reach a solution for a linear system of equations. As mentioned, in preconditioning, a matrix can be multiplied by a preconditioning matrix (e.g., “preconditioner”) that may make a linear system of equations more amenable to numerical solution without introducing unacceptable artifacts, error, etc.

Single or multi-stage preconditioners may be combined with Krylov subspace methods for solving a fully implicit or an adaptive implicit system of equations. As an example, consider an iterative procedure such as GMRES, which can accelerate convergence in a Krylov subspace.

As to the system 460, in the example of FIG. 4, it includes one or more processors 462, memory 464, instructions 466 and other features 468 (e.g., one or more features of a computing platform such as a desktop computer, a laptop computer, a server, a workstation, etc.).

The method 410 is shown in FIG. 4 in association with various computer-readable media (CRM) blocks 413, 417, 421, and 425. Such blocks can include instructions suitable for execution by one or more processors (or cores) to instruct a computing device or system to perform one or more actions. While various blocks are shown, a single medium may be configured with instructions to allow for, at least in part, performance of various actions of the method 410. As an example, a computer-readable medium (CRM) may be a computer-readable storage medium that is non-transitory and not a carrier wave.

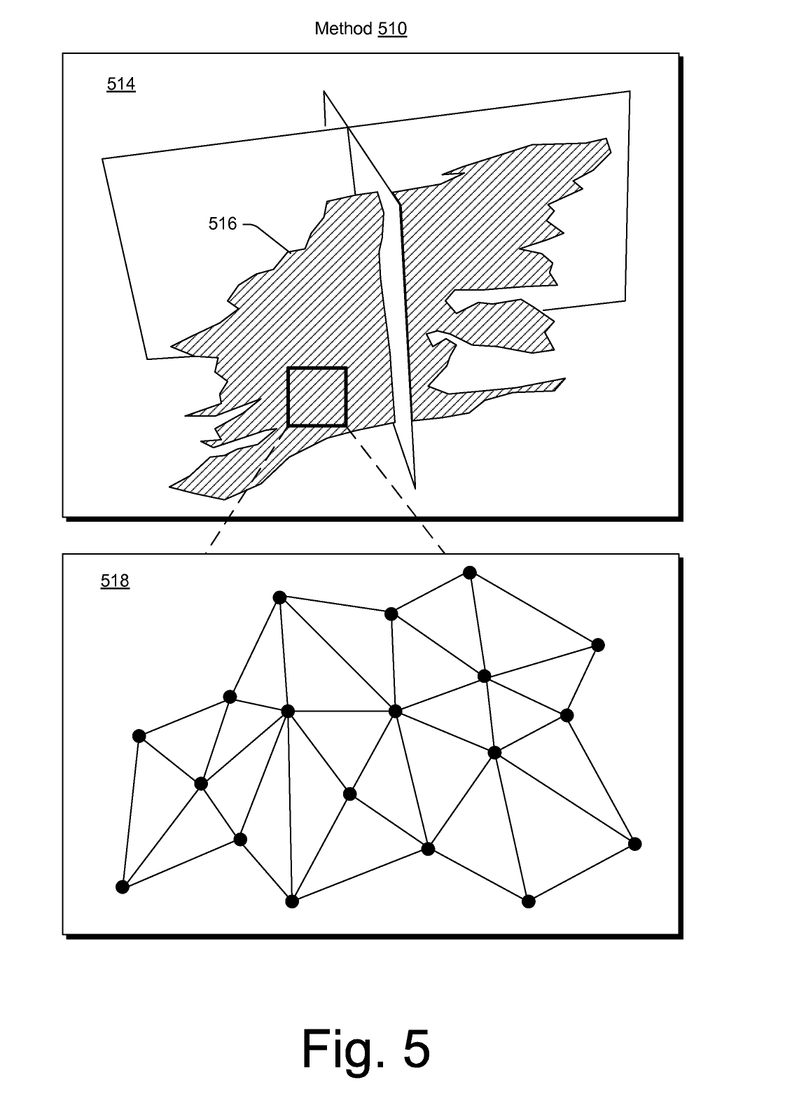

FIG. 5 shows an example of a method 510 that includes an identification block 514 for identifying a subterranean structure 516, for example, based at least in part on information acquired using an acquisition technique in a geologic environment. For example, such information may include seismic data and/or data derived from seismic data. As shown, the method 510 also includes a tessellation block 518 for tessellating at least a portion of the identified structure 516. For example, tessellating may include “covering” a surface with triangles (e.g., representing a surface in space with triangular elements). As an example, a subterranean structure may be represented by elements, which may be, for example, triangular elements.

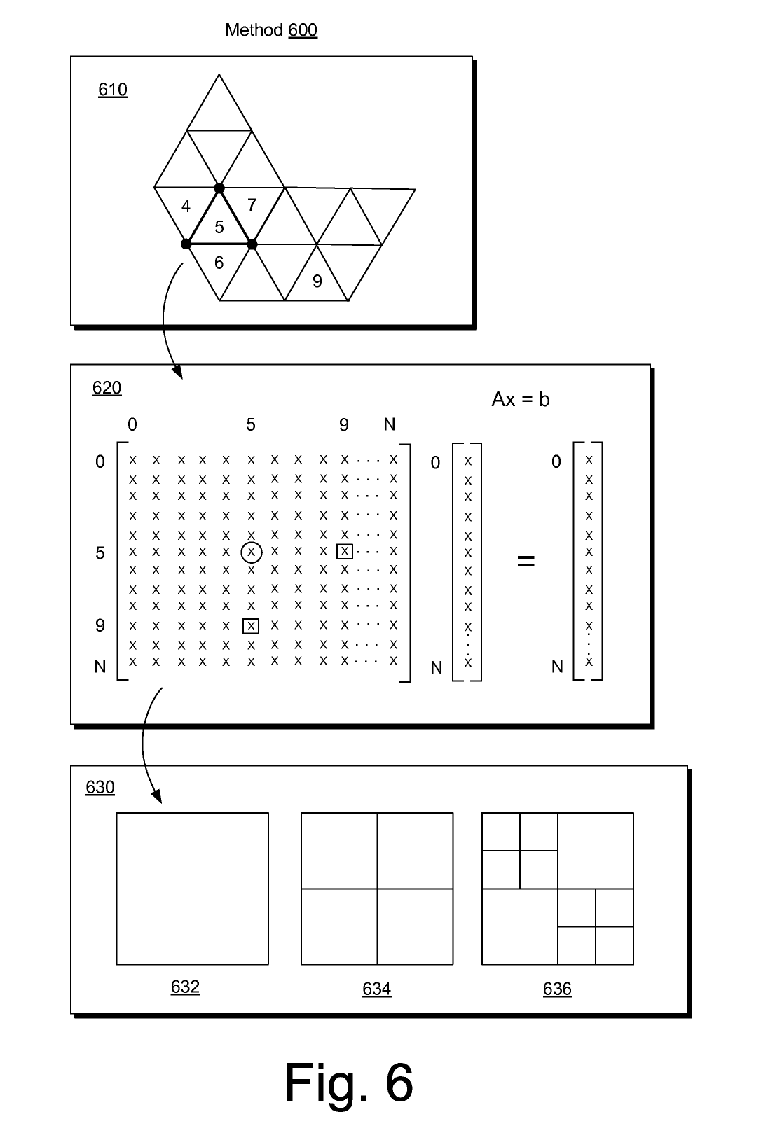

FIG. 6 shows an example of a method 600 that includes a model block 610 for receiving a boundary element model that includes boundary elements that may be numbered from 0 to N and a formulation block 620 that includes formulating a system of equations for the elements where an N×N array (e.g., an N×N matrix) may be dense in that it includes interaction terms where an individual boundary element interacts with other individual boundary elements. For example, a diagonal entry can exist for the boundary element having number 5 and an interaction entry can exist for interactions between the boundary element having number 5 and the boundary element having number 9 (e.g., x_{5,9} or x_{9,5}), which may not be an adjacent neighbor of the boundary element having number 5 (see, e.g., the numbered elements of the model block 610). Thus, due to interactions, the boundary element method tends to include formulation of dense arrays (e.g., dense matrixes).

The method 600 of FIG. 6 also includes a hierarchical decomposition block 630 that can decompose an array 632 (e.g., a dense matrix) into blocks where more blocks may be represented along a diagonal and fewer off the diagonal.

As an example, a sub-matrix block of a theoretical matrix (e.g., a matrix given via application of the boundary element method) can describe an interaction of two subsets of elements. For example, such a block may include interaction terms. In such an example, individual elements may be labeled from 0 to N where N is the number of elements of a model and where a subset of elements can be seen as a subset of index of {1,2, . . . , N}. As an example, an algorithm may include comparing blocks for elements in two regions, for example, by analyzing a distance between an element in one region and an element in another region.

Example of Pseudocode

```
Let X and Y be two Cartesian regions of a three-dimensional space.
Denote E(X) to be a set of elements contained within the region X.
Let Card(X) denote the cardinal of E(X).
Denote S(X) to be a bisection of X (e.g., as obtained by via a hierarchical
octree decomposition approach).
Define X diameter as follows:
                    diam(X) = max_{p,q in X}||p − q||
Define distance between X and Y as follows:
                  dist(X, Y) = min_{p in X,q in Y}||p − q||
Denote X*Y the Cartesian product.
Determine whether X*Y is admissible to classification as “near” according
to:
                  Min {diam(X), diam(Y)} ≦ a dist (X, Y)
where a is real positive number, optionally unity (e.g., a parameter that
may be set by default, by a user, or other approach).
```

As an example, an algorithm may form pairs of a cluster recursively. As an example of an algorithm, referred to as a BuildBlockTree algorithm (BBT) can form pairs of a cluster recursively. For example, the BBT defines an H-matrix as a tree structure where the interaction between two regions or blocks X and Y is either accurately computed (e.g., a full block) or approximated (e.g., a sparse block). As an example, an approximation may be based on an adaptive cross-approximation (ACA) algorithm.

Example of Pseudocode

//input: Call the BuildBlockTree algorithm, as below, with A=B=the model.
//output: an H-matrix stored as a tree (e.g., a tree data structure).
//note: Nmin is a parameter that controls the cardinality of a block (e.g., number of elements). Nmin is model dependent parameter and may be set as a small fraction of the total number of elements.

```
BuildBlockTree (A*B)
If Card(A) < Nmin or Card(B) < Nmin then
      Allocate a full block ‘A*B’
Return
EndIf
If A*B is admissible then
Allocate a Sparse block ‘A*B’
Return
else
S(A*B)= {A′*B′ where A′ is in S(A), B′ is in S(B)}
            For A′*B′ in S(A*B) do
                  BuildBlockTree(A′*B′)
            EndFor
EndIf
```

As an example, a method may implement a technique such as an incomplete lower upper (ILU) with threshold (ILUT) factorization of a matrix A that computes sparse lower and upper matrices (e.g., matrix decomposition). As an example, a standard ILU algorithm may rely on levels of fill independently of the numerical values; whereas, an ILUT algorithm can be rule-based as it includes a “dropping entries rule”. Such a rule may be based on one or more criteria, for example, to ignore small values.

Example Pseudocode (ILUT Algorithm)

1. For i = 1, ..., n Do:
2. ω := a_{i*}
3. For k = 1, ... i − 1 and when ωₖ ≠ 0 Do:
4. ωₖ := ωₖ/aₖₖ
5. Apply a dropping rule to ωₖ
6. if ωₖ ≠ 0 then
7. ω := ω − ωₖ * u_{k*}
8. EndIf
9. EndDo
10. Apply a dropping rule to row ω
11. l_{i,j} := ωⱼ for j = 1, ..., i − 1
12. u_{i,j} := ωⱼ for j = i, ..., n
13. ω := 0
14. EndDo

In the foregoing example pseudocode, in lines 5 and 10, the dropping rules replace entries by zero if some values are less than a certain relative threshold. As an example, a method can include receiving at least a portion of a data structure structured via implementation of an H-matrix technique, for example, to introduce into an ILUT procedure a dropping rule. For example, such a rule may be introduced as a third dropping rule into the example pseudocode. As an example, introduction of an H-matrix associated type of dropping rule may expedite computation (e.g., reduce computation time).

As an example, with reference to the example ILUT pseudocode, above, matrix blocks that are approximated (e.g., deemed to be far blocks) may be dropped, for example, by introducing into the pseudocode, for example, at line 2, a dropping rule. In such an example, an instruction may load the i-th row which may be, due to formulation of equations via boundary elements (e.g., BEM), fully populated and lacking in symmetry. An appropriate dropping rule can make the i-th row sparse, which, in turn, may result in a decrease in computation time.

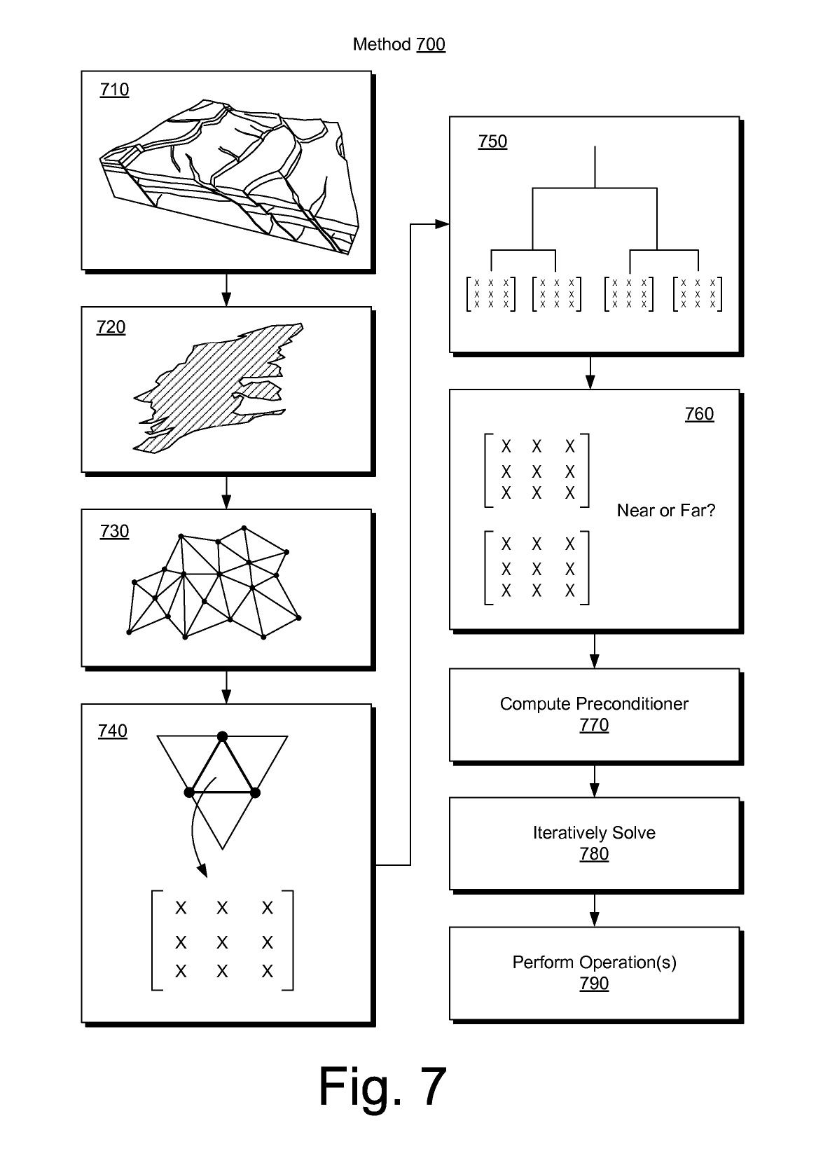

FIG. 7 shows an example of a method 700 that includes a reception block 710 for receiving information about a geologic environment, an identification block 720 for identifying a structure in the geologic environment based at least in part on the information, a tessellation block 730 for representing at least a portion of the identified structure with elements, a formulation block 740 for formulating sets of equations based at least in part on the elements where the sets of equations may be represented at least in part via arrays (e.g., where a local array for an element can include terms dependent on neighboring elements), a bisection block 750 for bisecting a plurality of arrays into a tree structure that includes blocks, a classification block 760 for determining whether blocks are to be classified as “near” or as “far” (e.g., by applying one or more criteria), a computation block 770 for computing a preconditioner (e.g., a preconditioner matrix or other preconditioner data structure) using blocks deemed to be “near” (e.g., optionally via an ILU technique that includes a rule based at least in part on classification of a block), a solution block 780 for iteratively solving a system of equations (e.g., with at least one data structure preconditioned by the preconditioner) to output a solution and a performance block 790 for performing one or more operations in the geologic environment based at least in part on the solution. For example, an operation may include a drilling operation, a fracturing operation, an extraction operation, an injection operation, etc.

As an example, the method 700, or a portion thereof, may be part of a workflow. For example, where a geologic environment includes a reservoir, the method 700 may be performed as part of a workflow to develop the reservoir (e.g., via field operations, etc.). As an example, development of a reservoir can include extracting one or more resources (e.g., hydrocarbons, etc.) from the reservoir.

As an example, a method may include solving a system of equations formulated according to the BEM to output a solution and performing an operation based at least in part on the solution. In such an example, an H-matrix technique may be applied to reduce memory demands and a preconditioner may be computed using blocks that are deemed to be “near” blocks while blocks deemed to be “far” blocks are excluded from the computation of the preconditioner. Such a preconditioner may be applied to one or more data structures that represent a system of equations to be solved. As an example, an iterative solver may implement a GMRES approach (e.g., consider the generalized minimal residual method as an iterative method for the numerical solution of a nonsymmetric system of linear equations). In such an example, the preconditioner may expedite convergence and make the iterative solver more robust to geometry of subterranean structures modeled using boundary elements (e.g., formulated according to the BEM).

As an example, an H-matrix technique may be applied to equations that correspond to boundary elements that discretize a physical space to find far-field blocks (e.g., within a tree data structure) that may be discarded for purposes of computing an ILU-based preconditioner. For example, a rule may be formulated for an ILU procedure that acts to ignore, discard, etc. far-field blocks. As an example, such an approach may reduce computation time and may stabilize computation with respect to geometry associated with a structure represented in space by boundary elements.

As an example, an H-matrix technique may be applied to reduce storage space of entries of a matrix of a system of equations associated with boundary element discretization of a physical space (e.g., to reduce a memory footprint of a matrix of a system of equations). In such an example, the technique may generate a tree structure (e.g., kd-tree, octree, etc.). As an example, blocks in a tree structure may be classified as being near or fair, for example, according to one or more criteria. As an example, a preconditioner, applicable to an iterative solution technique (e.g., GMRES), may be computed using blocks classified as being near (e.g., without using blocks classified as being far). As an example, blocks classified as being far may be considered to be classified as approximated blocks while blocks classified as being near may be considered to be classified as exact blocks (e.g., more accurately represented than approximated blocks).

As an example, a data structure resulting from application of an H-matrix technique may be applied to post-process a solution of an iterative solver where the solver includes preconditioning using a preconditioner computed based at least in part on application of the H-matrix technique. As an example, application of an H-matrix technique may result in a data structure that can be used for one or more processes (e.g., a preconditioner computation process, post-processing, etc.).

As an example, a method can include receiving a system of equations with associated variables that describe physical phenomena associated with a geologic formation; representing a matrix for the system of equations as a tree of blocks; classifying a portion of the blocks as being near blocks and another portion of the blocks as being far blocks; and based on the classification of the near blocks, computing a preconditioner for an iterative solver for solving the system of equations. In such an example, the method may include allocating memory of a computing device based at least in part on application of an H-matrix technique.

As an example, a method may include applying a preconditioner to precondition a matrix and, for example, solving the system of equations based at least in part on the preconditioned matrix. In such an example, the preconditioner may be computed using an H-matrix technique that can, for example, neglect one or more blocks of a matrix. For example, blocks classified as far blocks (e.g., based on at least one criterion) may be neglected to compute a preconditioner such that, for example, the preconditioner is computed using blocks classified as near blocks.

As an example, a method can include representing a matrix by recursively splitting of at least a portion of the matrix into a hierarchy of blocks. As an example, a method can include classifying blocks at least in part based on a diameter criterion, at least in part based on a distance criterion or at least in part on a diameter criterion and at least in part on a distance criterion.

As an example, a method can include receiving a system of equations with associated variables that describe physical phenomena associated with a geologic formation where the system of equations include coordinates associated with elements of a boundary element model. As an example, elements may include boundary elements that represent a surface. For example, consider a surface that corresponds to a discontinuity that defines at least two regions.

As an example, a method can include receiving a system of equations with associated variables that describe physical phenomena associated with a geologic formation where the system of equations includes coordinates associated with elements of a finite element model.

As an example, a method can include solving a system of equations to determine displacement values where the solving includes applying a preconditioner computed at least in part on the basis of an H-matrix technique. As an example, a method can include solving a system of equations to determine stress values where the solving includes applying a preconditioner computed at least in part on the basis of an H-matrix technique.

As an example, a system can include a processor; memory; and at least one modules stored in the memory that includes processor-executable instructions to instruct the system where the instructions can include instructions to receive a system of equations with associated variables that describe physical phenomena associated with a geologic formation; represent a matrix for the system of equations as a tree of blocks; classify a portion of the blocks as being near blocks and another portion of the blocks as being far blocks; and based at least in part on the classification of the near blocks, compute a preconditioner for an iterative solver for solving the system of equations. In such an example, the system can include processor-executable instructions to allocate a portion of the memory to compute the preconditioner based at least in part on application of an H-matrix technique.

As an example, a system can include processor-executable instructions to apply a preconditioner to precondition a matrix and to solve a system of equations based at least in part on the preconditioned matrix where the preconditioner is computed at least in part on the basis of an H-matrix technique.

As an example, a system can receive a system of equations with associated variables that describe physical phenomena associated with a geologic formation where the system of equations include coordinates associated with elements of a boundary element model, a finite element model or a boundary element and finite element model.

As an example, one or more computer-readable storage media can include processor-executable instructions to instruct a computing system where the instructions include instructions to receive a system of equations with associated variables that describe physical phenomena associated with a geologic formation; represent a matrix for the system of equations as a tree of blocks; classify a portion of the blocks as being near blocks and another portion of the blocks as being far blocks; and based at least in part on the classification of the near blocks, compute a preconditioner for an iterative solver for solving the system of equations. In such an example, processor-executable instructions may be included to allocate a portion of the memory to compute the preconditioner based at least in part on application of an H-matrix technique.

As an example, one or more computer-readable media can include processor-executable instructions to apply a preconditioner to precondition a matrix and to solve the system of equations based at least in part on the preconditioned matrix where the preconditioner is computed at least in part on the basis of an H-matrix technique.

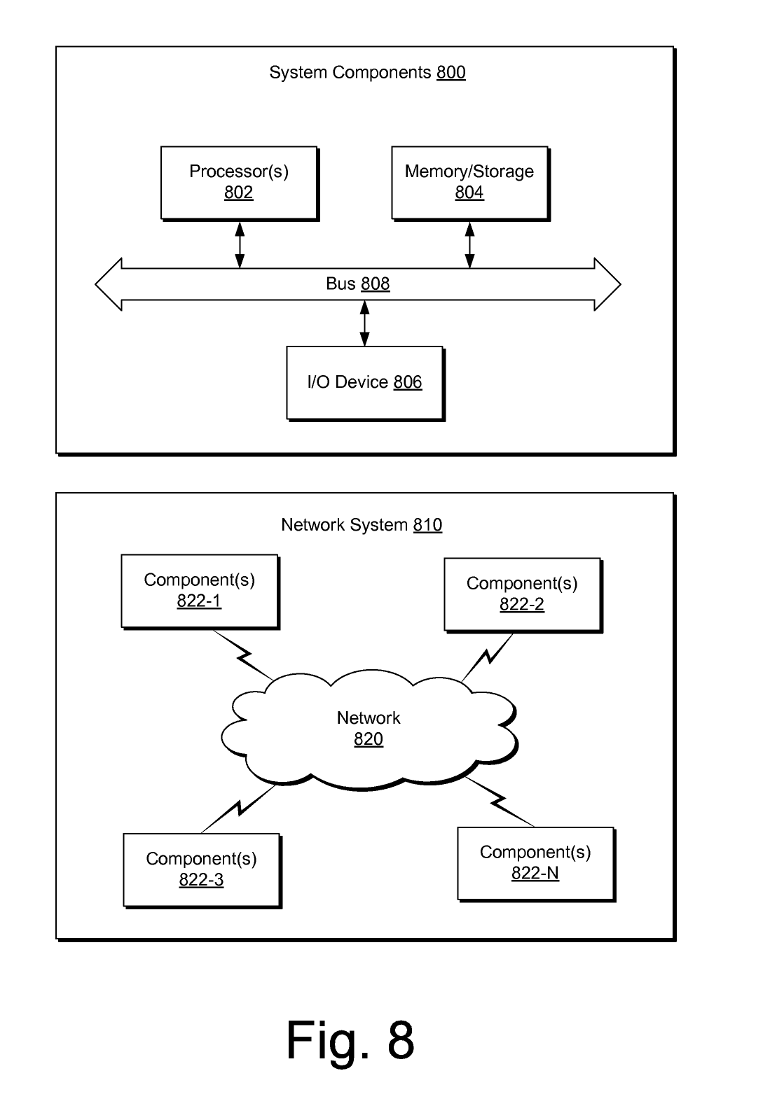

FIG. 8 shows components of an example of a computing system 800 and an example of a networked system 810. The system 800 includes one or more processors 802, memory and/or storage components 804, one or more input and/or output devices 806 and a bus 808. In an example embodiment, instructions may be stored in one or more computer-readable media (e.g., memory/storage components 804). Such instructions may be read by one or more processors (e.g., the processor(s) 802) via a communication bus (e.g., the bus 808), which may be wired or wireless. The one or more processors may execute such instructions to implement (wholly or in part) one or more attributes (e.g., as part of a method). A user may view output from and interact with a process via an I/O device (e.g., the device 806). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 810. The network system 810 includes components 822-1, 822-2, 822-3, . . . 822-N. For example, the components 822-1 may include the processor(s) 802 while the component(s) 822-3 may include memory accessible by the processor(s) 802. Further, the component(s) 802-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

1. A method comprising:
receiving a system of equations with associated variables that describe physical phenomena associated with a geologic formation;
representing a matrix for the system of equations as a tree of blocks;
classifying a portion of the blocks as being near blocks and another portion of the blocks as being far blocks; and
based at least in part on the classification of the near blocks, computing a preconditioner for an iterative solver for solving the system of equations.

2. The method of claim 1 further comprising allocating memory of a computing device based at least in part on application of an H-matrix technique.

3. The method of claim 1 further comprising applying the preconditioner to precondition a matrix.

4. The method of claim 3 further comprising solving the system of equations based at least in part on the preconditioned matrix.

5. The method of claim 1 wherein the representing the matrix comprises recursively splitting of at least a portion of the matrix into a hierarchy of blocks.

6. The method of claim 1 wherein the classifying comprises classifying at least in part based on a diameter criterion.

7. The method of claim 1 wherein the classifying comprises classifying at least in part based on a distance criterion.

8. The method of claim 1 wherein the system of equations with associated variables that describe physical phenomena associated with a geologic formation comprise coordinates associated with elements of a boundary element model.

9. The method of claim 8 wherein the elements comprise boundary elements that represent a surface.

10. The method of claim 9 wherein the surface corresponds to a discontinuity that defines at least two regions.

11. The method of claim 1 wherein the system of equations with associated variables that describe physical phenomena associated with a geologic formation comprise coordinates associated with elements of a finite element model.

12. The method of claim 1 further comprising solving the system of equations to determine displacement values.

13. The method of claim 1 further comprising solving the system of equations to determine stress values.

14. A system comprising:
a processor;
memory; and
one or more modules stored in the memory wherein the one or more modules comprise processor-executable instructions to instruct the system wherein the instructions comprise instructions to
receive a system of equations with associated variables that describe physical phenomena associated with a geologic formation;
represent a matrix for the system of equations as a tree of blocks;
classify a portion of the blocks as being near blocks and another portion of the blocks as being far blocks; and
based on the classification of the near blocks, compute a preconditioner for an iterative solver for solving the system of equations.

15. The system of claim 14 further comprising processor-executable instructions to allocate a portion of the memory to compute the preconditioner based at least in part on application of an H-matrix technique.

16. The system of claim 14 further comprising processor-executable instructions to apply the preconditioner to precondition a matrix and to solve the system of equations based at least in part on the preconditioned matrix.

17. The system of claim 14 wherein the system of equations with associated variables that describe physical phenomena associated with a geologic formation comprise coordinates associated with elements of a boundary element model, a finite element model or a boundary element and finite element model.

18. One or more computer-readable storage media comprising processor-executable instructions to instruct a computing system wherein the instructions comprise instructions to
receive a system of equations with associated variables that describe physical phenomena associated with a geologic formation;
represent a matrix for the system of equations as a tree of blocks;
classify a portion of the blocks as being near blocks and another portion of the blocks as being far blocks; and
based on the classification of the near blocks, compute a preconditioner for an iterative solver for solving the system of equations.

19. The one or more computer-readable media of claim 18 further comprising processor-executable instructions to allocate a portion of the memory to compute the preconditioner based at least in part on application of an H-matrix technique.

20. The one or more computer-readable media of claim 18 further comprising processor-executable instructions to apply the preconditioner to precondition a matrix and to solve the system of equations based at least in part on the preconditioned matrix.
